(19) United States
(12) Patent Application Publication
(10) Pub. No.: US 2008/0112196 A1
(43) Pub. Date: May 15, 2008

(54) Portable, variable power supply

(76) Inventor: WAYNE HUM, Toronto (CA)

Correspondence Address: WAYNE HUM, 522 MANNING AVENUE, TORONTO, ON, M6G 2V7, omitted

(21) Appl. No.: 11/938,790

(22) Filed: Nov. 13, 2007

(30) Foreign Application Priority Data
Nov. 14, 2006 (CA) 2,568,106

(51) Int. Cl. H02M 5/42

(52) U.S. Cl. 363/76

(57) ABSTRACT

A portable, variable power supply is provided according to the invention. The portable power supply will be a variable power supply comprised of at least one power unit which is further comprised of at least one power cell. Two or more power units will operably connect to configurable, control switches to enable selection of the various customizable configurations. The variable supply will have at least one operable connection to attach to devices.

### CROSS-REFERENCE TO RELATED APPLICATIONS

This application claims priority from previously filed Canadian application #2,568,106.

### BACKGROUND OF THE INVENTION

With the number and variety of personal devices ever on the rise and the constant demand for longer usage times, it doesn't hurt to have extra power on hand to help power and/or extend the usage time of some of these devices. Enter the invention a portable, variable power supply created to accomodate as many devices as possible. A similar art in the field would be Canadian patent #2,010,066 showing a power supply having a transformer, a device attachment with a singular output designed for a single proprietary device. This is unlike the present invention which may allow for multiple attachments with custom, variable output selections to accomodate as many devices as possible, some simultaneously.

### SUMMARY OF THE INVENTION

A portable, variable, power supply is provided according to the invention. The variable power supply will allow users to custom configure and select the various configurations.

### BRIEF DESCRIPTION OF THE DRAWINGS

FIG. 1 is a schematical view of the variable power supply with multiple selector and multiple attachment capabilities.

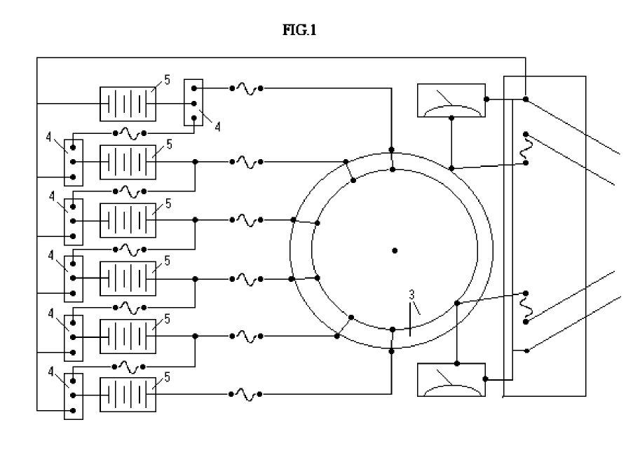

FIG. 2 is a schematical view of another embodiment of the present invention with multiple selector and multiple attachment capabilities.

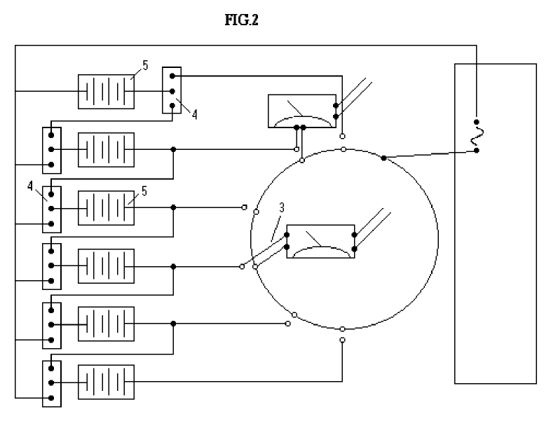

### DETAILED DESCRIPTION OF THE INVENTION

The portable, variable, power supply will be comprised of at least one or more power units (5) and a control system. Each power unit will comprise at least one power cell. A power cell being anything that can supply electric power. Each power unit will be operably connected to various switches/selectors (4)&(3) to enable variable, selectable configurations. Each power unit will be able to be operably engaged or disengaged to the system by a switch (4) and/or operably coupled or decoupled with other power units to provide variable, selectable configurations. The control system will comprise at least one switch (4), and at least one selector mechanism (3). The invention will have at least one operable connection to attach to devices. Users will configure and select an output most appropriate for a device, or devices in the case of a multiple output embodiment.

Current cell technologies come in a wide variety of types, for example this may include: Alkaline, Zinc Carbon, Nickel Cadmium [Ni—Cd], Nickel Metal, Hydride [Ni-MH], Lithium Ion [Li-ion], Lithium Polymer [Li-Po], Lithium Thionyl [CE], Lithium Manganese [CR], sealed lead-acid, and gel cell to name a few. The current invention may make use of any or all of these and any other technologies in order to make the power supply as effective as possible. Preference will be given to anything that can supply electric power.

Although the invention has been described in connection with a preferred embodiment, it should be understood that various modifications, additions and alterations may be made to the invention by one skilled in the art without departing from the spirit and scope of the invention.

1. A portable, variable power supply comprising at least one power unit which is further comprised of at least one power cell, a control system with at least one switch and at least one selector mechanism, and at least one operable connection to attach to devices.

2. A power cell according to claim 1, whereby a power cell can be anything that can supply electric power.

3. A power unit according to claim 1, whereby two or more power units will be operably connected through the control system's various switches to allow each to be operably engaged or disengaged to the system and/or operably coupled or decoupled with each other such that a multitude of usable configurations can be set and selected.
